(19) United States
(12) Patent Application Publication
(10) Pub. No.: US 2026/0218979 A1
(43) Pub. Date: Jul. 30, 2026

(54) LIQUEFIED HYDROGEN FACILITY AND METHOD FOR OPERATING SAME

(71) Applicant: KAWASAKI JUKOGYO KABUSHIKI KAISHA, Kobe-shi, Hyogo (JP)

(72) Inventors: Yoshia KOSHI, Kobe-shi, Hyogo (JP); Yuma NAITO, Kobe-shi, Hyogo (JP); Yoshihiro MATSUDA, Kobe-shi, Hyogo (JP)

(73) Assignee: KAWASAKI JUKOGYO KABUSHIKI KAISHA, Kobe-shi, Hyogo (JP)

(21) Appl. No.: 19/142,234

(22) PCT Filed: Dec. 12, 2023
(86) PCT No.: PCT/JP2023/044437

§ 371 Date: Jun. 23, 2025

(30) Foreign Application Priority Data
Dec. 28, 2022 (JP) 2022-211902

(51) Int. Cl. F25J 1/00; F25J 1/02

(52) U.S. Cl. CPC F25J 1/001; F25J 1/0245; F25J 1/0254; F25J 1/0267; F25J 1/0278; F25J 2240/40; F25J 2245/90

(57) ABSTRACT

A liquefied hydrogen facility includes: a raw material feed line that connects a raw material feed source and a liquefier; a storage tank that stores liquefied hydrogen; a cargo handling line that connects the storage tank and a carrier; a reflux line that guides to the liquefier each of a return gas returned from the carrier at cargo handling and a boil-off gas from the storage tank; a first valve provided on the raw material feed line; and a second valve provided on the reflux line. At the cargo handling, an opening degree of the second valve is controlled in a direction in which a fluctuation in an inlet pressure of the liquefier is suppressed. At a normal time, an opening degree of the first valve is controlled in a direction in which the fluctuation in the inlet pressure of the liquefier is suppressed.

### TECHNICAL FIELD

The present disclosure relates to a liquefied hydrogen facility that handles liquefied hydrogen and a method for operating the facility.

### BACKGROUND ART

A liquefied hydrogen facility is known that liquefies a hydrogen gas and performs storage and cargo handling of liquefied hydrogen. For example, Patent Literature 1 below discloses a liquefied hydrogen facility including: a liquefier (liquefied hydrogen production device) that liquefies a raw material hydrogen gas supplied from a raw material hydrogen feed source; a storage tank that stores liquefied hydrogen that is liquefied by the liquefier; and a reflux line (boil-off gas introduction passage) that returns, to the liquefier, a boil-off gas generated at the cargo handling of liquefied hydrogen from the storage tank to a liquefied hydrogen transport ship. The boil-off gas returned to the liquefier through the reflux line is re-liquefied by the liquefier to be used.

Since liquefied hydrogen has a boiling point much lower than that of liquefied natural gas (LNG) and the like, a relatively large amount of boil-off gas is generated due to heat input at the cargo handling to a carrier such as a liquefied hydrogen transport ship. Therefore, a flow rate of the boil-off gas at the cargo handling, that is, the flow rate of the boil-off gas that is refluxed to the liquefier to be re-liquefied, tends to be considerably larger than a flow rate of the raw material hydrogen gas supplied from the above-described raw material feed source. This means that the flow rate of the hydrogen gas introduced into the liquefier largely fluctuates between the time of cargo handling and the time other than the time of cargo handling (normal time), in other words, an inlet pressure of the liquefier can largely fluctuate. In operation of the liquefier, it is desirable to keep the inlet pressure constant, and it is not desirable that the inlet pressure largely fluctuates. That is, a large fluctuation in the inlet pressure of the liquefier may cause a problem such as a failure of the liquefier.

### CITATION LIST

### Patent Literature

Patent Literature 1: JP 2013-242021 A

### SUMMARY OF INVENTION

The present disclosure has been made in view of the above circumstances, and an object of the present disclosure is to provide a liquefied hydrogen facility capable of stabilizing an inlet pressure of a liquefier, and a method for operating the liquefied hydrogen facility.

In order to solve the above problem, a facility according to one aspect of the present disclosure is a liquefied hydrogen facility that generates liquefied hydrogen and transfers the liquefied hydrogen to a carrier, and the liquefied hydrogen facility includes: a liquefier that liquefies a hydrogen gas to generate liquefied hydrogen; a raw material feed line that guides a raw material hydrogen gas from a raw material feed source to the liquefier; a storage tank that stores the liquefied hydrogen generated by the liquefier; a reflux line that guides to the liquefier each of a return gas that is a hydrogen gas returned from the carrier along with cargo handling for transferring the liquefied hydrogen from the storage tank to the carrier and a boil-off gas generated by evaporation of the liquefied hydrogen in the storage tank; a first valve provided on the raw material feed line; a second valve provided on the reflux line; and a controller that controls the first valve and the second valve. The controller controls, at the cargo handling, an opening degree of the second valve in a direction in which a fluctuation in an inlet pressure of the liquefier is suppressed, and the controller controls, at a normal time when the cargo handling is not performed, an opening degree of the first valve in a direction in which the fluctuation in the inlet pressure of the liquefier is suppressed.

Furthermore, a method according to another aspect of the present disclosure is a method for operating a liquefied hydrogen facility including the above-described liquefier, raw material feed line, storage tank, reflux line, first valve, and second valve, and the method includes: determining which phase the liquefied hydrogen facility is in, a cargo handling phase in which cargo handling is performed or a normal phase in which the cargo handling is not performed; controlling, when the liquefied hydrogen facility is determined to be in the cargo handling phase, an opening degree of the second valve in a direction in which a fluctuation in an inlet pressure of the liquefier is suppressed; and controlling, when the liquefied hydrogen facility is determined to be in the normal phase, an opening degree of the first valve in a direction in which the fluctuation in the inlet pressure of the liquefier is suppressed.

With the liquefied hydrogen facility and the method for operating the liquefied hydrogen facility of the present disclosure, it is possible to stabilize the inlet pressure of the liquefier; therefore, a performance in liquefaction of a hydrogen gas by the liquefier can be favorably maintained.

### BRIEF DESCRIPTION OF DRAWINGS

FIG. 1 is a system diagram illustrating an overall configuration of a liquefied hydrogen facility according to one embodiment of the present disclosure.

FIG. 2 is a functional block diagram illustrating a control system of the liquefied hydrogen facility.

FIG. 3 is a flowchart illustrating details of control performed by a controller during operation of the liquefied hydrogen facility.

FIG. 4 is an explanatory diagram for describing a content of valve control performed at a normal time.

FIG. 5 is an explanatory diagram for describing a content of valve control performed at cargo handling.

### DESCRIPTION OF EMBODIMENTS

### Configuration of Liquefied Hydrogen Facility

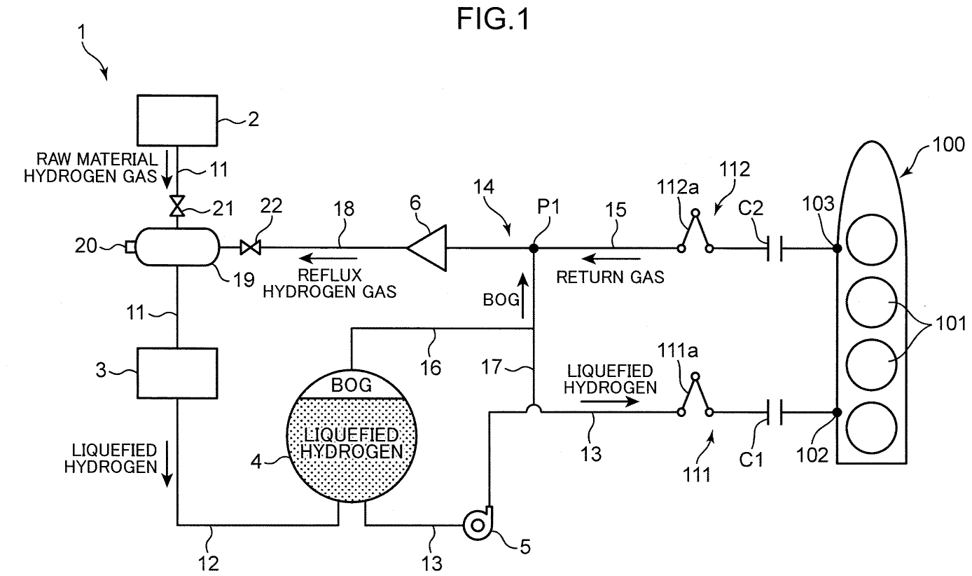

FIG. 1 is a system diagram showing an overall configuration of a liquefied hydrogen facility 1 according to one embodiment of the present disclosure. The liquefied hydrogen facility 1 illustrated in the figure is a facility for storing liquefied hydrogen obtained by liquefying a hydrogen gas and for performing cargo handling of the stored liquefied hydrogen to a carrier ship 100 (carrier). Specifically, the liquefied hydrogen facility 1 includes: a raw material feed source 2 that supplies a raw material hydrogen gas before being liquefied; a liquefier 3 that liquefies the raw material hydrogen gas supplied from the raw material feed source 2; a storage tank 4 that stores liquefied hydrogen generated by the liquefier 3; a liquefied hydrogen pump 5 that delivers the liquefied hydrogen from the storage tank 4 to a carrier ship 100; and a compressor 6 that re-introduces, into the liquefier 3, a return gas from the carrier ship 100 and a reflux hydrogen gas containing a boil-off gas.

The above-described elements are connected to each other via a plurality of passages. Specifically, the liquefied hydrogen facility 1 includes: a raw material feed line 11 that connects the raw material feed source 2 and the liquefier 3; a liquefied hydrogen feed line 12 that connects the liquefier 3 and the storage tank 4; a cargo handling line 13 that connects the storage tank 4 and the carrier ship 100; and a reflux line 14 that connects the carrier ship 100 and the raw material feed line 11.

The raw material feed source 2 is an apparatus that generates a hydrogen gas and supplies the hydrogen gas as a raw material of liquefied hydrogen to the liquefier 3. From the raw material feed source 2 to the liquefier 3, a raw material hydrogen gas that is highly pressurized up to, for example, about several MPa is supplied. The type of the raw material feed source 2 is not limited as long as it can generate a hydrogen gas, and for example, an apparatus that generates a hydrogen gas from hydrocarbon such as methane by steam reforming can be used as the raw material feed source 2. Alternatively, an apparatus that generates a hydrogen gas by electrolysis of water may be used as the raw material feed source 2.

The high-pressure raw material hydrogen gas supplied from the raw material feed source 2 is introduced into the liquefier 3 through the raw material feed line 11. The liquefier 3 liquifies the introduced raw material hydrogen gas by expanding the raw material hydrogen gas while cooling, and thereby generates a liquefied hydrogen. The liquefier 3 may be of any type as long as the hydrogen gas can be cooled and liquefied, and may be configured to include, for example, a cooler that cools the hydrogen gas to a state immediately before liquefaction by heat exchange using a refrigeration cycle and to include a Joule-Thomson valve that liquefies a hydrogen gas cooled by the cooler by performing Joule-Thomson expansion (equal enthalpy expansion).

A buffer tank 19 having an enlarged volume is provided midway of the raw material feed line 11. A downstream end of the reflux line 14 is connected to the buffer tank 19. In the buffer tank 19, the raw material hydrogen gas supplied from the raw material feed source 2 and the reflux hydrogen gas introduced through the reflux line 14 join together. The hydrogen gas after joining is introduced from the buffer tank 19 into the liquefier 3 and is liquefied. In other words, the liquefier 3 liquefies the raw material hydrogen gas from the raw material feed source 2 and re-liquefies the reflux hydrogen gas from the reflux line 14.

The liquefied hydrogen generated by the liquefier 3 is introduced into the storage tank 4 through the liquefied hydrogen feed line 12. The storage tank 4 stores the introduced liquefied hydrogen while keeping the liquefied hydrogen cool. The storage tank 4 can be, for example, a multiple shell tank including an inner tank that stores liquefied hydrogen and an outer tank that is disposed outside the inner tank and forms a vacuum insulation layer between the inner tank and the outer tank.

The liquefied hydrogen stored in the storage tank 4 is delivered from the storage tank 4 by the liquefied hydrogen pump 5 at the cargo handling in which the liquefied hydrogen is transferred to the carrier ship 100. The liquefied hydrogen pump 5 sucks the liquefied hydrogen from the storage tank 4 and discharges the liquefied hydrogen to the downstream side. The liquefied hydrogen discharged from the liquefied hydrogen pump 5 is sent to the carrier ship 100 through the cargo handling line 13.

The cargo handling line 13 is connected to the receiving portion 102 of the carrier ship 100 via a loading machine 111. The loading machine 111 is installed in a harbor at which the carrier ship 100 is docked, and loads the liquefied hydrogen sent from the cargo handling line 13 on the carrier ship 100. The loading machine 111 includes a loading arm 111a having an articulated structure. The loading arm 111a is connected to the carrier ship 100 via a connection portion C1.

The carrier ship 100 has a storing tank 101 in which liquefied hydrogen is stored. The liquefied hydrogen sent from the cargo handling line 13 is supplied to the storing tank 101 via the loading machine 111 and stored in the storing tank 101 while being kept cold. Before the cargo handling of the liquefied hydrogen onto the carrier ship 100 is performed, the storing tank 101 is filled with a hydrogen gas. When the liquefied hydrogen is supplied to the storing tank 101 by the cargo handling, the hydrogen gas is discharged from the storing tank 101 such that the hydrogen gas is pushed out by the supplied liquefied hydrogen. Furthermore, a boil-off gas generated by evaporation of the liquefied hydrogen due to heat input is also discharged from the storing tank 101. These hydrogen gases, that is, the mixed gas of the hydrogen gas present in the storing tank 101 before the cargo handling and the boil-off gas generated by evaporation during the cargo handling, are discharged to the downstream side from a discharge portion 103 of the carrier ship 100 as a return gas.

The discharge portion 103 of the carrier ship 100 is connected to the reflux line 14 via an unloading machine 112. The unloading machine 112 is installed in the vicinity of the loading machine 111 in the harbor, and sends the return gas discharged from the carrier ship 100 to the reflux line 14. The unloading machine 112 includes a loading arm 112a having an articulated structure. The loading arm 112a is connected to the carrier ship 100 via the connection portion C2.

The reflux line 14 includes the return line 15, a BOG line 16, a branch line 17, and a downstream line 18. The return line 15 is a passage extending from the connection portion C2 of the unloading machine 112 toward the compressor 6. The BOG line 16 is a passage extending from the storage tank 4 towards the return line 15. The return line 15 and the BOG line 16 join together at a joining point P1 on the upstream side of the compressor 6. The downstream line 18 is a shared passage that connects the joining point P1 and the buffer tank 19 on the raw material feed line 11. The branch line 17 is a passage branching from a part on the downstream side of the liquefied hydrogen pump 5 on the cargo handling line 13. A downstream end of the branch line 17 is connected to a midway part of the BOG line 16.

The reflux line 14 is used to reintroduce a hydrogen gas containing boil-off gas and the like generated in various parts into the liquefier 3. That is, inside the storage tank 4, there is a boil-off gas (BOG) generated by evaporation of the liquefied hydrogen due to heat input. The boil-off gas is introduced into the joining point P1 through the BOG line 16. On the other hand, at the cargo handling of liquefied hydrogen, a boil-off gas is also generated when the liquefied hydrogen is flowing through the cargo handling line 13. This boil-off gas is introduced into the joining point P1 through the branch line 17. Furthermore, the return gas returned from the carrier ship 100 at the cargo handling of the liquefied hydrogen is introduced into the joining point P1 through the return line 15. Each gas (reflux hydrogen gas) that has reached the joining point P1 is refluxed to the buffer tank 19 through the downstream line 18.

Here, since the liquefied hydrogen is not delivered from the storage tank 4 to the carrier ship 100 at a normal time when the cargo handling of the liquefied hydrogen is not performed, boil-off gas is not generated in the cargo handling line 13, and the return gas is not returned from the carrier ship 100. Therefore, at the normal time, only the boil-off gas returning from the storage tank 4 through the BOG line 16 is introduced into the buffer tank 19 as the reflux hydrogen gas. On the other hand, at the cargo handling of liquefied hydrogen, in addition to the boil-off gas from the storage tank 4, both the boil-off gas returning from the cargo handling line 13 through the branch line 17 and the return gas returning from the carrier ship 100 through the return line 15 are introduced into the buffer tank 19. In other words, the reflux hydrogen gas introduced into the buffer tank 19 at the cargo handling contains both the boil-off gas from each of the storage tank 4 and the cargo handling line 13 and the return gas from the carrier ship 100.

The compressor 6 is a device that pressure-feeds a hydrogen gas, and is provided midway of the downstream line 18. The compressor 6 pushes out the reflux hydrogen gas flowing through the downstream line 18 to the downstream side, and thereby sends the reflux hydrogen gas to the buffer tank 19.

The buffer tank 19 is provided with a pressure sensor 20. The pressure sensor 20 is a sensor that detects an internal pressure of the buffer tank 19. Here, the internal pressure of the buffer tank 19 is the pressure of the hydrogen gas immediately before being introduced into the liquefier 3, and is equivalent to an inlet pressure of the liquefier 3. In other words, the pressure sensor 20 is a sensor that detects the inlet pressure of the liquefier 3.

A first valve 21 is provided at a part on the upstream side of the buffer tank 19 on the raw material feed line 11. The first valve 21 is an automatic valve including a valve body and an actuator that opens and closes the valve body. A pressure of the raw material hydrogen gas introduced from the raw material feed source 2 into the buffer tank 19 can be adjusted by controlling an opening degree of the first valve 21.

A second valve 22 is provided in the vicinity of the buffer tank 19 on the reflux line 14, specifically, provided midway of the downstream line 18 located between the compressor 6 and the buffer tank 19. The second valve 22 is an automatic valve similar to the above-described first valve 21. The pressure of the reflux hydrogen gas introduced into the buffer tank 19 through the reflux line 14 can be adjusted by controlling an opening degree of the second valve 22.

### Operation of Liquefied Hydrogen Facility

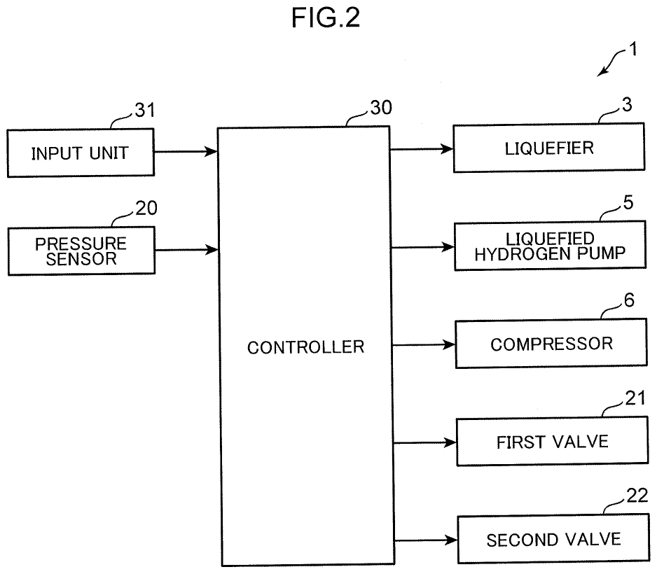

Next, an operation example of the above-described liquefied hydrogen facility 1 will be described. FIG. 2 is a functional block diagram illustrating a control system of the liquefied hydrogen facility 1. As illustrated in the figure, the liquefied hydrogen facility 1 further includes: a controller 30 that comprehensively controls operation of the facility during operation of the liquefied hydrogen facility 1; and an input unit 31 that receives an operation from an operator. The controller 30 is a control device including, as a main part, a microcomputer that includes, for example: a processor (CPU) that performs calculation; memories such as a ROM and a RAM; and various input/output buses. The input unit 31 is an interface operated by an operator to input various instructions and the like related to the operation of the liquefied hydrogen facility 1.

An operation signal is input to the controller 30 from the input unit 31, and a pressure detection signal is input to the controller 30 from the above-described pressure sensor 20. Based on these pieces of information having been input, the controller 30 controls various control objects in the liquefied hydrogen facility 1. Specifically, based on conditions of the operator's operation on the input unit 31 and on the internal pressure of the buffer tank 19 detected by the pressure sensor 20, the controller 30 controls each of the liquefier 3, the liquefied hydrogen pump 5, the compressor 6, the first valve 21, and the second valve 22.

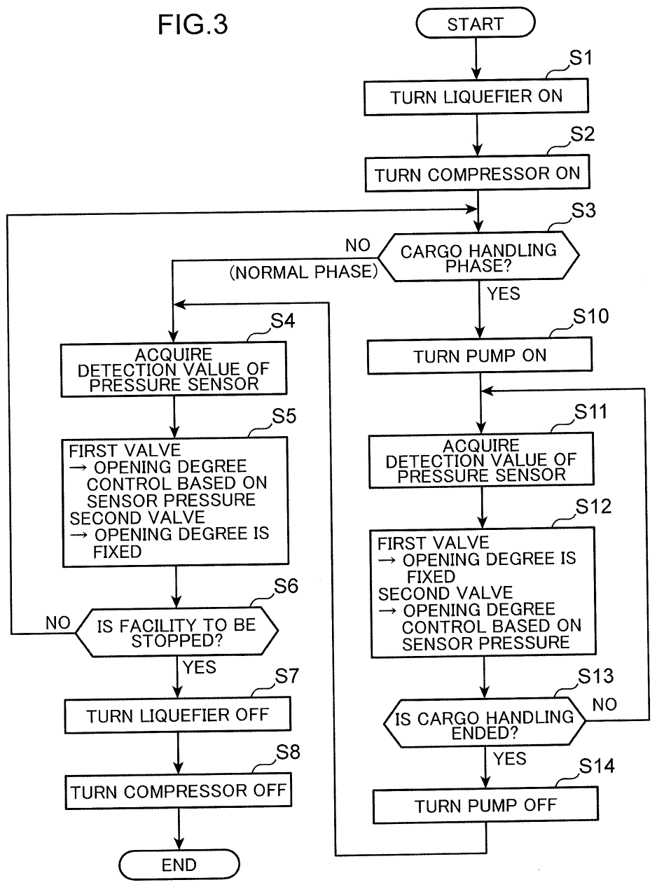

FIG. 3 is a flowchart illustrating details of the control performed by the controller 30 during the operation of the liquefied hydrogen facility 1. When the control illustrated in the figure starts upon receiving a signal to start the liquefied hydrogen facility 1, the controller 30 drives the liquefier 3 and the compressor 6 (steps S1 and S2). As a result, the hydrogen gas is liquefied by the liquefier 3, and the generated liquefied hydrogen is sent to the storage tank 4. Furthermore, the reflux hydrogen gas is pressure-fed by the compressor 6, and the reflux hydrogen gas is returned to the buffer tank 19.

Next, based on input information from the input unit 31, the controller 30 determines whether the liquefied hydrogen facility 1 is in the cargo handling phase (step S3). For example, when the carrier ship 100 is docked at the harbor and is ready to receive liquefied hydrogen, the operator operates the input unit 31 to issue an instruction to perform the cargo handling of the liquefied hydrogen from the storage tank 4 to the carrier ship 100. In step S3, the controller 30 determines whether the liquefied hydrogen facility 1 is in the cargo handling phase, based on the presence or absence of such an instruction from the operator through the input unit 31.

When the determination in step S3 is NO, that is, when it is confirmed that the liquefied hydrogen facility 1 is not in the cargo handling phase but in the normal phase, the controller 30 acquires a detection value of the internal pressure of the buffer tank 19 from the pressure sensor 20 (step S4).

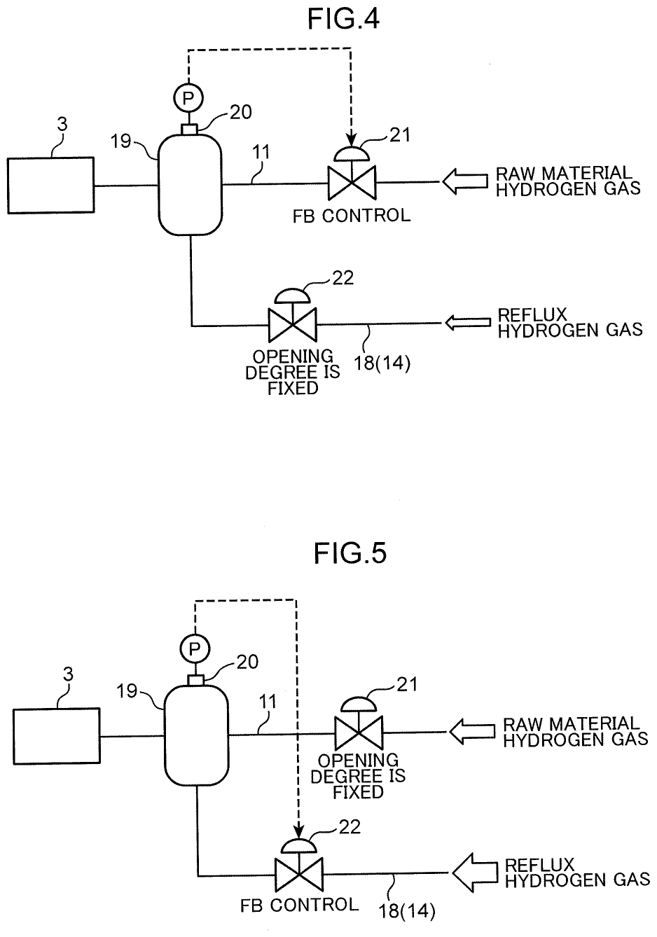

Next, as illustrated in FIG. 4, the controller 30 controls the opening degree of the first valve 21, based on a sensor pressure acquired in step S4, and fixes the opening degree of the second valve 22 to a constant value (step S5).

Specifically, in step S5, the controller 30 subtracts a previously specified target pressure from the internal pressure of the buffer tank 19 detected by the pressure sensor 20, and determines a value obtained by the subtraction as a pressure deviation. Then, the opening degree of the first valve 21 is feedback-controlled based on the determined pressure deviation. For example, when the pressure deviation is positive, the first valve 21 is controlled such that the opening degree becomes smaller as the pressure deviation becomes larger toward the positive side, that is, as the internal pressure of the buffer tank 19 largely exceeds the target pressure. Conversely, when the pressure deviation is negative, the first valve 21 is controlled such that the opening degree becomes larger as the pressure deviation becomes larger toward the negative side, that is, as the internal pressure of the buffer tank 19 is largely below the target pressure.

The above-described control of the opening degree of the first valve 21 adjusts the pressure of the raw material hydrogen gas introduced from the raw material feed source 2 into the buffer tank 19, based on the pressure deviation, and thereby acts to stabilize the internal pressure of the buffer tank 19 (in other words, the inlet pressure of the liquefier 3) in the vicinity of the target pressure. In other words, the opening degree of the first valve 21 is controlled in a direction in which a fluctuation in the inlet pressure of the liquefier 3 is suppressed at the normal time when the cargo handling of the liquefied hydrogen is not performed.

On the other hand, on the second valve 22, the opening degree control based on the pressure deviation is not performed. The opening degree of the second valve 22 is fixed to a predetermined opening degree other than full closing. This means that the reflux hydrogen gas (here, the boil-off gas from the storage tank 4) passing through the reflux line 14 is introduced into the buffer tank 19 without being subjected to pressure adjustment. Therefore, although the pressure of the reflux hydrogen gas may fluctuate depending on conditions, this fluctuation is cancelled by the above-described pressure adjustment of the raw material hydrogen gas by the first valve 21. As a result, the internal pressure of the buffer tank 19 is maintained in the vicinity of the target pressure, and the fluctuation in the inlet pressure of the liquefier 3 is suppressed.

Next, based on the input information from the input unit 31, the controller 30 determines whether an operation to stop the liquefied hydrogen facility 1 has been performed (step S6).

When the determination in step S6 is NO and it is therefore confirmed that the operation to stop the facility has not been performed, the controller 30 repeats the above-described processing in step S3 and thereafter.

On the other hand, when the determination in step S6 is YES and it is therefore determined that the operation to stop the facility has been performed, the controller 30 stops the liquefier 3 and the compressor 6 (steps S7 and S8).

Next, a description will be given on control when the determination in step S3 is YES, that is, when the liquefied hydrogen facility 1 is in the cargo handling phase. In this case, the controller 30 drives the liquefied hydrogen pump 5 (step S10). As a result, the liquefied hydrogen is delivered from the storage tank 4 to the carrier ship 100, and the liquefied hydrogen is thereby handled into the storing tank 101 of the carrier ship 100.

Next, the controller 30 acquires the detection value of the internal pressure of the buffer tank 19 from the pressure sensor 20 (step S11).

Next, as illustrated in FIG. 5, the controller 30 fixes the opening degree of the first valve 21 to a constant value, and controls the opening degree of the second valve 22, based on the sensor pressure acquired in step S11 (step S12).

Specifically, in step S12, the controller 30 subtracts the previously specified target pressure from the internal pressure of the buffer tank 19 detected by the pressure sensor 20, and determines a value obtained by the subtraction as a pressure deviation. Then, the opening degree of the second valve 22 is feedback-controlled based on the determined pressure deviation. For example, when the pressure deviation is positive, the second valve 22 is controlled such that the opening degree becomes smaller as the pressure deviation becomes larger toward the positive side, that is, as the internal pressure of the buffer tank 19 largely exceeds the target pressure. Conversely, when the pressure deviation is negative, the second valve 22 is controlled such that the opening degree becomes larger as the pressure deviation becomes larger toward the negative side, that is, as the internal pressure of the buffer tank 19 is largely below the target pressure.

Here, when the liquefied hydrogen facility 1 is in the cargo handling phase, that is, when the liquefied hydrogen is handled from the storage tank 4 to the carrier ship 100, the reflux hydrogen gas passing through the downstream line 18 of the reflux line 14 contains the return gas from the carrier ship 100, the boil-off gas from the cargo handling line 13, and the boil-off gas from the storage tank 4. The above-described control of the opening degree of the second valve 22 adjusts the pressure of the reflux hydrogen gas in which these gases are mixed, based on the pressure deviation, and thereby acts to stabilize the internal pressure of the buffer tank 19 (in other words, the inlet pressure of the liquefier 3) in the vicinity of the target pressure. In other words, the opening degree of the second valve 22 is controlled in a direction in which the fluctuation in the inlet pressure of the liquefier 3 is suppressed at the cargo handling of the liquefied hydrogen.

On the other hand, on the first valve 21, the opening degree control based on the pressure deviation is not performed. The opening degree of the first valve 21 is fixed to a previously specified predetermined opening degree. The predetermined opening degree here is set to an appropriate opening degree other than full closing. The fact that the opening degree of the first valve 21 is fixed to an opening degree other than full closing means that the raw material hydrogen gas from the raw material feed source 2 is introduced into the buffer tank 19 without being subjected to pressure adjustment. Therefore, although the pressure of the raw material hydrogen gas may fluctuate depending on conditions, this fluctuation is cancelled by the above-described pressure adjustment of the reflux hydrogen gas by the second valve 22. As a result, the internal pressure of the buffer tank 19 is maintained in the vicinity of the target pressure, and the fluctuation in the inlet pressure of the liquefier 3 is suppressed.

Next, the controller 30 determines whether the cargo handling phase has ended (step S13). For example, when it is confirmed that a prescribed amount of liquefied hydrogen is stored in the storing tank 101 of the carrier ship 100, the operator operates the input unit 31 to issue an instruction to end the cargo handling work. In step S13, the controller 30 determines whether the cargo handling phase has ended, based on the presence or absence of such an instruction from the operator through the input unit 31.

When the determination in step S13 is NO and it is therefore confirmed that the cargo handling phase is continued, the controller 30 repeats the above-described processing in step S11 and thereafter.

On the other hand, when the determination in step S13 is YES and it is therefore confirmed that the cargo handling phase has ended, the controller 30 stops the liquefied hydrogen pump 5 (step S14). Thereafter, the flow proceeds to step S4.

### Action and Effect

As described above, in the present embodiment, the first valve 21 is provided on the raw material feed line 11 that guides the raw material hydrogen gas to the liquefier 3, and the second valve 22 is provided on the reflux line 14 through which the reflux hydrogen gas to be reintroduced into the liquefier 3 passes. On the buffer tank 19 located at a part where the raw material feed line 11 and the reflux line 14 join together, there is provided the pressure sensor 20 that detects the internal pressure, and the pressure detected by the pressure sensor 20 is reflected in the control of the opening degree of the first valve 21 or the second valve 22. Specifically, at the cargo handling for transferring the liquefied hydrogen from the storage tank 4 to the carrier ship 100, control is executed to increase or decrease the opening degree of the second valve 22 based on the detected pressure while fixing the opening degree of the first valve 21, and at the normal time when cargo handling is not performed, the control is executed to increase or decrease the opening degree of the first valve 21 based on the detected pressure while fixing the opening degree of the second valve 22. Such a configuration can stabilize the inlet pressure of the liquefier 3, and the performance in liquefaction of the hydrogen gas by the liquefier 3 can therefore be favorably maintained.

That is, in the present embodiment, depending on whether it is the time of cargo handling or the normal time (non-cargo-handling time) the inlet pressure of the liquefier 3 is adjusted using either the first valve 21 on the raw material feed line 11 through which the raw material hydrogen gas passes or the second valve 22 on the reflux line 14 through which the reflux hydrogen gas passes. Therefore, as compared with a case where both the valves 21 and 22 are control objects, a problem on control such as hunting hardly occurs, and the fluctuation in the inlet pressure of the liquefier 3 can be appropriately suppressed.

For example, in the normal time when the cargo handling of the liquefied hydrogen is not performed, the reflux hydrogen gas refluxed to the liquefier 3 through the reflux line 14 does not contain the return gas from the carrier ship 100, and the flow rate of the reflux hydrogen gas is therefore relatively small. In other words, at the normal time, the flow rate of the raw material hydrogen gas introduced into the liquefier 3 through the raw material feed line 11 tends to be larger than the flow rate of the reflux hydrogen gas. At such a normal time, in the present embodiment, since only the opening degree of the first valve 21 on the raw material feed line 11 is controlled based on the detected pressure, it is possible to efficiently adjust, while preventing a problem such as hunting, the inlet pressure of the liquefier 3 by controlling the opening degree of the first valve 21; therefore, it is possible to appropriately suppress the fluctuation in the inlet pressure of the liquefier 3 by the above pressure adjustment.

On the other hand, at the cargo handling for transferring the liquefied hydrogen to the carrier ship 100, a relatively large amount of the reflux hydrogen gas containing the return gas from the carrier ship 100 is returned to the liquefier 3 through the reflux line 14; therefore, the flow rate of the reflux hydrogen gas tends to be larger than the flow rate of the raw material hydrogen gas. At such a cargo handling, in the present embodiment, since only the opening degree of the second valve 22 on the reflux line 14 is controlled based on the detected pressure, it is possible to efficiently adjust, while preventing a problem such as hunting, the inlet pressure of the liquefier 3 by controlling the opening degree of the second valve 22; therefore, it is possible to appropriately suppress the fluctuation in the inlet pressure of the liquefier 3 by the above pressure adjustment.

As described above, in the present embodiment, the fluctuation in the inlet pressure of the liquefier 3 can be suppressed by appropriate valve control in accordance with an operation phase such as the time of cargo handling or the normal time; therefore, the inlet pressure of the liquefier 3 can be stabilized regardless of the operation phase, and the performance in liquefaction of the hydrogen gas by the liquefier 3 can be favorably maintained.

Furthermore, in the present embodiment, only one of the first valve 21 and the second valve 22 is the control object for pressure adjustment at the cargo handling or at the normal time, and the opening degree of the remaining valve is fixed. Therefore, it is not necessary to consider the influence on the pressure due to a change in the opening degree of the remaining valve, and the inlet pressure of the liquefier 3 can therefore be stabilized with a simple and rational configuration.

Furthermore, in the present embodiment, since the downstream end of the reflux line 14 (downstream line 18) is connected to the buffer tank 19 provided between the first valve 21 and the liquefier 3 on the raw material feed line 11, a minute pressure fluctuation between the raw material hydrogen gas from the raw material feed source 2 and the reflux hydrogen gas from the reflux line 14 can be absorbed by the buffer tank 19.

### Variations

Although a preferred embodiment of the present disclosure has been described above, the present disclosure is not limited thereto, and for example, the following variations are possible.

In the above embodiment, at the cargo handling for transferring liquefied hydrogen from the storage tank 4 to the carrier ship 100, the opening degree of the second valve 22 is controlled based on the detection value detected by the pressure sensor 20 (in other words, the inlet pressure of the liquefier 3) while the opening degree of the first valve 21 is fixed to a constant value. However, the opening degree of the first valve 21 is not necessarily fixed to a constant value. That is, the opening degree of the first valve 21 at the cargo handling only needs to be a value determined independently of the inlet pressure of the liquefier 3, and for example, the opening degree of the first valve 21 may be variably set based on another parameter different from the inlet pressure of the liquefier 3.

Similarly, in the above embodiment, at the normal time when the cargo handling of the liquefied hydrogen is not performed, the opening degree of the first valve 21 is controlled based on the detection value detected by the pressure sensor 20 (in other words, the inlet pressure of the liquefier 3) while the opening degree of the second valve 22 is fixed to a constant value. However, the opening degree of the second valve 22 is not necessarily fixed to a constant value. That is, the opening degree of the second valve 22 at the normal time only needs to be a value determined independently of the inlet pressure of the liquefier 3, and for example, the opening degree of the second valve 22 may be variably set based on another parameter different from the inlet pressure of the liquefier 3.

In the above embodiment, the determination between the time of cargo handling and the normal time, that is, the determination of whether the operation phase is the cargo handling phase or the normal phase is performed based on an instruction from the operator through the input unit 31, but the method for determining the operation phase is not limited thereto. For example, the operation phase may be determined based on whether the liquefied hydrogen pump 5 for delivering the liquefied hydrogen from the storage tank 4 is operating. Alternatively, a flow rate sensor may be attached to an appropriate part of the reflux line 14, and the operation phase may be determined based on a flow rate of the reflux hydrogen gas detected by the flow rate sensor.

In the above embodiment, the internal pressure of the buffer tank 19 is detected by the pressure sensor 20, and the detected pressure is treated as the inlet pressure of the liquefier 3. However, the pressure sensor only needs to detect a pressure at any place as long as the pressure is equivalent to the inlet pressure of the liquefier 3, and for example, a pressure sensor may be attached to a midway part of the raw material feed line 11 located between the buffer tank 19 and the liquefier 3. Alternatively, the pressure sensor may be a sensor that directly detects the inlet pressure of the liquefier 3.

The above embodiment has described an example in which the liquefied hydrogen stored in the storage tank 4 is handled onto the carrier ship 100, but a destination of the cargo handling of the liquefied hydrogen only needs to be a carrier that transports liquefied hydrogen, and may be, for example, a transport vehicle such as a tank truck.

### Conclusion

The above embodiment and the variations thereof include the following disclosure.

A facility according to one aspect of the present disclosure is a liquefied hydrogen facility that generates liquefied hydrogen and transfers the liquefied hydrogen to a carrier, the liquefied hydrogen facility including: a liquefier that liquefies a hydrogen gas to generate liquefied hydrogen; a raw material feed line that guides a raw material hydrogen gas from a raw material feed source to the liquefier; a storage tank that stores the liquefied hydrogen generated by the liquefier; a reflux line that guides to the liquefier each of a return gas that is a hydrogen gas returned from the carrier along with cargo handling for transferring the liquefied hydrogen from the storage tank to the carrier and a boil-off gas generated by evaporation of the liquefied hydrogen in the storage tank; a first valve provided on the raw material feed line; a second valve provided on the reflux line; and a controller that controls the first valve and the second valve. The controller controls, at the cargo handling, an opening degree of the second valve in a direction in which a fluctuation in an inlet pressure of the liquefier is suppressed, and the controller controls, at a normal time when the cargo handling is not performed, an opening degree of the first valve in a direction in which the fluctuation in the inlet pressure of the liquefier is suppressed.

With the present disclosure, the inlet pressure of the liquefier is adjusted using any one of the first valve on the raw material feed line that guides the raw material hydrogen gas to the liquefier and the second valve on the reflux line that guides to the liquefier the hydrogen gas including the return gas from the carrier and the boil-off gas from the storage tank (hereinafter, the gases guided by the reflux line are collectively referred to as a reflux hydrogen gas). Therefore, as compared with a case where both valves are control objects, a problem on control such as hunting hardly occurs, and the fluctuation in the inlet pressure of the liquefier can be appropriately suppressed.

For example, in the normal time when the cargo handling of the liquefied hydrogen is not performed, the reflux hydrogen gas refluxed to the liquefier through the reflux line does not contain the return gas from the carrier, and the flow rate of the reflux hydrogen gas is therefore relatively small. In other words, at the normal time, the flow rate of the raw material hydrogen gas introduced into the liquefier through the raw material feed line tends to be larger than the flow rate of the reflux hydrogen gas. At the above-described normal time, in the present disclosure, since the opening degree of the first valve on the raw material feed line is controlled, it is possible to efficiently adjust, while preventing a problem such as hunting, the inlet pressure of the liquefier by controlling the opening degree of the first valve; therefore, it is possible to appropriately suppress the fluctuation in the inlet pressure of the liquefier by the above pressure adjustment.

On the other hand, at the cargo handling for transferring the liquefied hydrogen to the carrier, a relatively large amount of the reflux hydrogen gas containing the return gas from the carrier is returned to the liquefier through the reflux line; therefore, the flow rate of the reflux hydrogen gas tends to be larger than the flow rate of the raw material hydrogen gas. At the above-described cargo handling, in the present disclosure, since the opening degree of the second valve on the reflux line is controlled, it is possible to efficiently adjust, while preventing a problem such as hunting, the inlet pressure of the liquefier by controlling the opening degree of the second valve; therefore, it is possible to appropriately suppress the fluctuation in the inlet pressure of the liquefier by the above pressure adjustment.

As described above, in the present disclosure, the fluctuation in the inlet pressure of the liquefier can be suppressed by appropriate valve control in accordance with an operation phase such as the time of cargo handling or the normal time; therefore, the inlet pressure of the liquefier can be stabilized regardless of the operation phase, and the performance in liquefaction of the hydrogen gas by the liquefier can be favorably maintained.

Preferably, the liquefied hydrogen facility further includes a pressure sensor that detects an inlet pressure of the liquefier. The controller controls, at the cargo handling, the opening degree of the second valve based on the inlet pressure detected by the pressure sensor while fixing the opening degree of the first valve, and the controller controls, at the normal time, the opening degree of the first valve based on the inlet pressure detected by the pressure sensor while fixing the opening degree of the second valve.

In this aspect, the valve that is the control object at each of the time of cargo handling and the normal time is controlled based on the inlet pressure of the liquefier detected by the pressure sensor, and, on the other hand, the opening degree of the valve that is not the control object is fixed to a constant value, so that the inlet pressure of the liquefier can be stabilized with a simple and reasonable configuration.

Preferably, the raw material feed line includes a buffer tank between the first valve and the liquefier, and a downstream end of the reflux line is connected to the buffer tank.

In this aspect, the buffer tank can absorb a minute pressure fluctuation between the raw material hydrogen gas from the raw material feed source and the reflux hydrogen gas from the reflux line.

Preferably, the pressure sensor detects an internal pressure of the buffer tank as an inlet pressure of the liquefier.

The internal pressure of the buffer tank is the pressure of a hydrogen gas obtained when the raw material hydrogen gas and the reflux hydrogen gas join together on the upstream side of the liquefier, and is equivalent to the inlet pressure of the liquefier. Therefore, by detecting the internal pressure of the buffer tank with the pressure sensor, the inlet pressure of the liquefier can be appropriately obtained.

Preferably, the reflux line includes: a downstream line connected to the raw material feed line; a return line that guides the return gas from the carrier to the downstream line; and a BOG line that guides the boil-off gas from the storage tank to the downstream line.

In this aspect, the return gas from the carrier and the boil-off gas from the storage tank can be appropriately refluxed to the liquefier as the reflux hydrogen gas.

A method according to another aspect of the present disclosure is a method for operating a liquefied hydrogen facility including the above-described liquefier, raw material feed line, storage tank, reflux line, first valve, and second valve, and the method includes: determining which phase the liquefied hydrogen facility is in, a cargo handling phase in which cargo handling is performed or a normal phase in which the cargo handling is not performed; controlling, when the liquefied hydrogen facility is determined to be in the cargo handling phase, an opening degree of the second valve in a direction in which a fluctuation in an inlet pressure of the liquefier is suppressed; and controlling, when the liquefied hydrogen facility is determined to be in the normal phase, an opening degree of the first valve in a direction in which the fluctuation in the inlet pressure of the liquefier is suppressed.

With the method for operation according to the present disclosure, similarly to the disclosure of the liquefied hydrogen facility described above, the inlet pressure of the liquefier can be stabilized regardless of the operation phase, so that the performance in liquefaction of the hydrogen gas by the liquefier can be favorably maintained.

### REFERENCE SIGNS

1 liquefied hydrogen facility
2 raw material feed source
3 liquefier
4 storage tank
11 raw material feed line
13 cargo handling line
14 reflux line
15 return line
16 BOG line
18 downstream line
19 buffer tank
20 pressure sensor
21 first valve
22 second valve
30 controller
100 carrier ship (carrier)

1. A liquefied hydrogen facility that generates liquefied hydrogen and transfers the liquefied hydrogen to a carrier, the liquefied hydrogen facility comprising:
a liquefier that liquefies a hydrogen gas to generate liquefied hydrogen;
a raw material feed line that guides a raw material hydrogen gas from a raw material feed source to the liquefier;
a storage tank that stores the liquefied hydrogen generated by the liquefier;
a reflux line that guides to the liquefier each of a return gas that is a hydrogen gas returned from the carrier along with cargo handling for transferring the liquefied hydrogen from the storage tank to the carrier and a boil-off gas generated by evaporation of the liquefied hydrogen in the storage tank;
a first valve provided on the raw material feed line;
a second valve provided on the reflux line; and
a controller that controls the first valve and the second valve,
wherein the controller controls, at the cargo handling, an opening degree of the second valve in a direction in which a fluctuation in an inlet pressure of the liquefier is suppressed, and
the controller controls, at a normal time when the cargo handling is not performed, an opening degree of the first valve in a direction in which the fluctuation in the inlet pressure of the liquefier is suppressed.

2. The liquefied hydrogen facility according to claim 1, further comprising a pressure sensor that detects an inlet pressure of the liquefier, wherein
the controller controls, at the cargo handling, the opening degree of the second valve based on the inlet pressure detected by the pressure sensor while fixing the opening degree of the first valve, and
the controller controls, at the normal time, the opening degree of the first valve based on the inlet pressure detected by the pressure sensor while fixing the opening degree of the second valve.

3. The liquefied hydrogen facility according to claim 2, wherein
the raw material feed line includes a buffer tank between the first valve and the liquefier, and
a downstream end of the reflux line is connected to the buffer tank.

4. The liquefied hydrogen facility according to claim 3, wherein the pressure sensor detects an internal pressure of the buffer tank as an inlet pressure of the liquefier.

5. The liquefied hydrogen facility according to claim 1, wherein
the reflux line includes: a downstream line connected to the raw material feed line; a return line that guides the return gas from the carrier to the downstream line; and a BOG line that guides the boil-off gas from the storage tank to the downstream line.

6. A method for operating a liquefied hydrogen facility that includes: a liquefier that liquefies a hydrogen gas to generate liquefied hydrogen; a raw material feed line that guides a raw material hydrogen gas from a raw material feed source to the liquefier; a storage tank that stores the liquefied hydrogen generated by the liquefier; a reflux line that guides to the liquefier each of a return gas that is a hydrogen gas returned from a carrier along with cargo handling for transferring the liquefied hydrogen from the storage tank to the carrier and a boil-off gas generated by evaporation of the liquefied hydrogen in the storage tank; a first valve provided on the raw material feed line; and a second valve provided on the reflux line, the method comprising:
determining which phase the liquefied hydrogen facility is in, a cargo handling phase in which cargo handling is performed or a normal phase in which the cargo handling is not performed;
controlling, when the liquefied hydrogen facility is determined to be in the cargo handling phase, an opening degree of the second valve in a direction in which a fluctuation in an inlet pressure of the liquefier is suppressed; and
controlling, when the liquefied hydrogen facility is determined to be in the normal phase, an opening degree of the first valve in a direction in which the fluctuation in the inlet pressure of the liquefier is suppressed.
